(19) United States
(12) Patent Application Publication
(10) Pub. No.: US 2011/0288695 A1
(43) Pub. Date: Nov. 24, 2011

(54) CONTROL INTERFACE FOR UNMANNED VEHICLES

(75) Inventors: Ryan GARIEPY, Kitchener (CA); Michael James PURVIS, Kitchener (CA)

(73) Assignee: CLEARPATH ROBOTICS, INC., Waterloo (CA)

(21) Appl. No.: 13/109,092

(22) Filed: May 17, 2011

Related U.S. Application Data
(60) Provisional application No. 61/344,071, filed on May 18, 2010.

(51) Int. Cl. G05D 1/00

(52) U.S. Cl. 701/2

(57) ABSTRACT

An unmanned vehicle system containing one or more vehicles equipped with an autonomous control system. Each vehicle is of navigating on its own when provided with goals. A user is capable of sending and receiving goals from the autonomous control system via a communication link. A unified display interface displays information about the system and accepts commands from the user. The display interface in question is modeless and has a minimum of clutter and distractions. The form of this display interface is that of a set of screens, each of which is able to receive touch inputs from the user. The user is able to monitor and control individual vehicles or the entirety of the UVS solely through their use of a standard touchscreen with no additional peripherals.

### CROSS-REFERENCE TO RELATED APPLICATIONS

The present application is claims priority from U.S. Provisional Patent Application No. 61/344,071 filed on 18 May 2010, the contents being incorporated herein by reference.

### FIELD

The specification relates generally to unmanned vehicles (“UVs”) and specifically to a control interface for unmanned vehicles.

### BACKGROUND

Autonomous unmanned vehicle systems (UVSs) have existed in research labs for decades, and are now seeing increasing use outside of these controlled environments, and in increasing numbers. UVSs are now being deployed whose sole purpose is not robotics research, instead serving as sensor platforms, remote manipulators, and cargo transports. With these uses, the primary concern of the user is not how the UVS performs its task, but that it performs its task properly and with as little operator supervision as possible.

Additionally, the deployment of vehicles in the field is made simpler by reducing dependence on complex ground control stations or operator control units. Traditionally, even the simplest operator control unit has multiple inputs, ranging from pushbuttons to joysticks. This forces users to standardize on a single method for interfacing with a UVS, which typically also dictates a corresponding form factor. If users are to control many different varieties of vehicles from a single operator control unit, it is a desirable to be able to control a UVS in as simple a manner as possible; preferably without external peripherals.

### SUMMARY

It is an object of the present invention to improve the usability of unmanned vehicle systems, whether these systems are comprised of a single vehicle or multiple vehicles. As well, it is a further object to ensure that the system interface is not dependent on a specific form factor for the control device. The user should be able to control the UVS from a smartphone, a netbook, a tablet PC, a workstation, or any variant on such computing platforms without any significant change in operating procedure.

The present invention is comprised of an unmanned vehicle system containing one or more vehicles equipped with an autonomous control systems. Each vehicle so equipped is capable of independent motion throughout an environment. Vehicles are capable of navigating on their own when provided with goals. These goals can be in the form of a desired instantaneous trajectory, an ordered set of waypoints, a delineated area, or any other set of criteria which can be understood by the autonomous control system.

Each vehicle may be outfitted with a suite of sensors which aid it in perceiving its state and the surrounding environment. They may also be capable of manipulating the environment via auxiliary manipulators or other actuation mechanisms.

A user is capable of sending and receiving goals from the autonomous control system via a communication link. This link can be wired or wireless, depending on specific hardware and environmental specifications. The user is also able to view sensor information and system status and issue other commands to the system. A unified display interface displays information about the system and its environment and also accepts commands from the user which may be issued directly to the system or translated into a suitable format. The form of this display interface is that of a set of screens, each of which is able to receive touch inputs from the user. Finally, the display interface in question is modeless and contains a minimum of potential distractions.

The user may interact with every aspect of the system without requiring a keyboard, joystick, mouse, or other interface device. The user is able to monitor and control individual vehicles or the entirety of the UVS solely through their use of a standard touchscreen.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts an exemplary embodiment of an unmanned vehicle;

FIG. 2 depicts the manner in which an exemplary embodiment of an unmanned vehicle may position itself;

FIG. 3 shows an exemplary system architecture of an unmanned vehicle;

FIG. 4 shows an exemplary electrical architecture of an unmanned vehicle;

FIG. 5 is an example of information flow within the exemplary unmanned vehicle's low-level control system;

FIG. 6 shows a possible network topology of a control system for unmanned vehicles;

FIG. 7 depicts an exemplary user interface for controlling an unmanned vehicle;

FIG. 8 depicts an exemplary user interface for controlling an unmanned vehicle wherein the user takes manual control of an unmanned vehicle;

FIG. 9 depicts an exemplary user interface for controlling an unmanned vehicle wherein the user directs an unmanned vehicle to proceed to a pre-existing key point or path;

FIG. 10 depicts an exemplary user interface for controlling an unmanned vehicle wherein the user extends a previously specified path for the unmanned vehicle to travel;

FIG. 11 depicts an exemplary user interface for controlling an unmanned vehicle wherein the user moves a previously specified waypoint along a path;

FIG. 12 depicts an exemplary user interface for controlling an unmanned vehicle wherein the user inserts a waypoint into a previously specified path;

FIG. 13 depicts an exemplary user interface for controlling an unmanned vehicle wherein the user adds a waypoint independent of a previously specified path;

FIG. 14 depicts an exemplary user interface for controlling an unmanned vehicle wherein the user delineates an area for use by the unmanned vehicle;

FIG. 15 depicts an exemplary user interface for controlling an unmanned vehicle wherein the user assigns an unmanned vehicle to an area; and

FIG. 16 depicts an auxiliary function menu as part of an exemplary user interface for controlling an unmanned vehicle.

FIG. 17 depicts a schematic block diagram of a control interface, according to non-limiting implementations.

### DETAILED DESCRIPTION

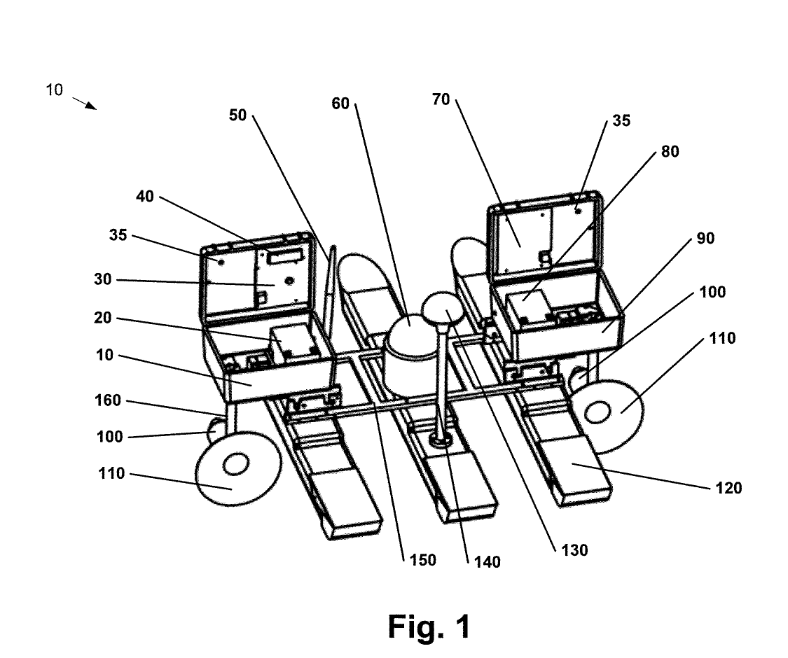

FIG. 1 depicts an exemplary embodiment of an unmanned vehicle 10 which may be used as part of the unmanned vehicle control system. The vehicle 10 shown is a waterborne unmanned surface vehicle (USV). The hull 120 and attached framework 150 provides a stable buoyant platform. The primary electrical enclosure 10 holds the primary control board 30 and the primary battery 20, while the auxiliary electrical enclosure 90 holds the auxiliary control board 70 and an auxiliary battery 80. Attached via shafts 160 to both enclosures 10, 90 are thruster assemblies 100 with appropriate propellers 110. Also attached to the primary electrical enclosure 10 is a status display 40, and a long-range bidirectional communications system 50. A plurality of additional sensors such as a camera system 60 and a GPS system 130 may also be emplaced on the hull 120, attached framework 150 or enclosures 10, 90. Sensors 60, 130 may be mounted on mounts 140 if required. Additionally, features such as port and starboard running lights 35 may be added as regulations and/or safety requirements dictate.

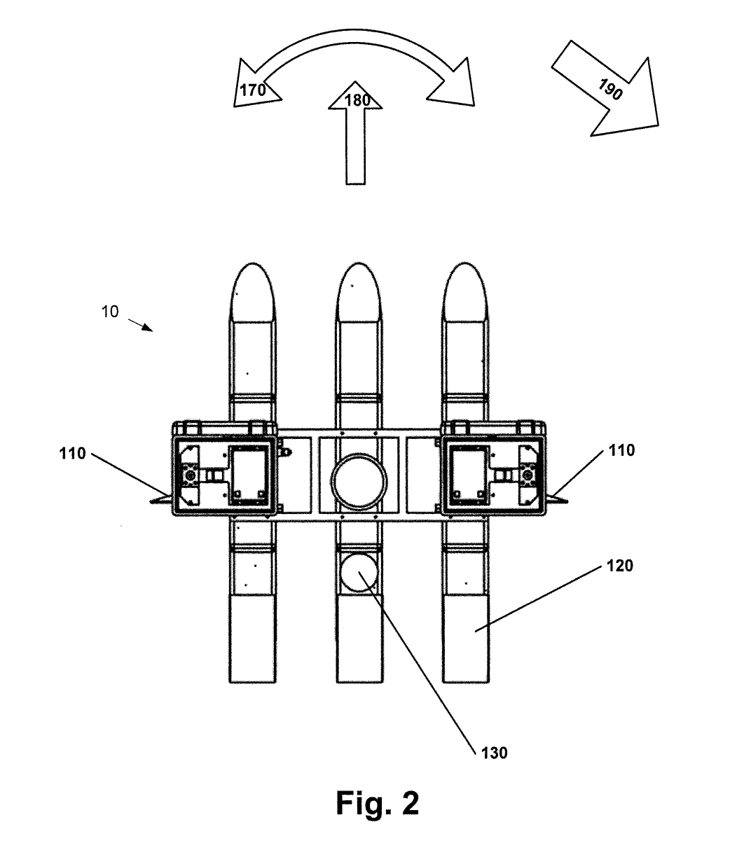

FIG. 2 depicts a manner in which the exemplary embodiment of the unmanned vehicle 10 may position itself. In a preferred embodiment of a USV, propellers 110 attached to the hull 120 can have their thrusts varied independently of each other. This method, known as differential drive to those skilled in the art, allows for the translational velocity 180 and rotational velocity 170 of the vehicle 10 to be decoupled from each other, resulting in superior vehicle maneuverability. In the example configuration shown, the thrusts of one or both of the propellers 110 can be reversed entirely, allowing the vehicle 10 to back up or turn in place. This further improves maneuverability. The vehicle 10 may also be subject to an external force 190 from wind or currents, which the control method can compensate for via the differential drive. Additional performance improvements in velocity tracking can be gained from estimating the external force 190 via adaptive or other similar control methods, known to those skilled in the art, and controlling the speeds of the propellers 110 accordingly.

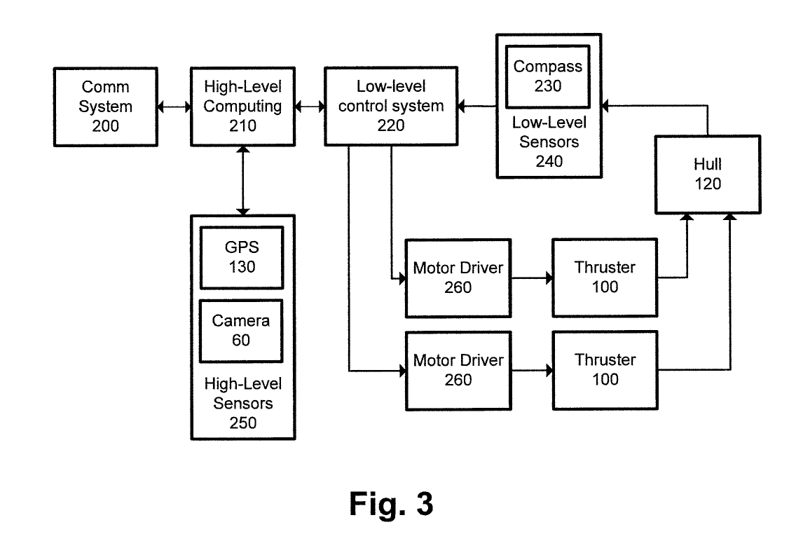

FIG. 3 shows an exemplary system architecture of the unmanned vehicle 10. The primary electrical enclosure 10 contains a high-level computing system 210, a comm. system 200, and a low-level control system 220. A GPS system 130 may also be mounted to the framework 150 and connected to the high-level computing system 210, allowing the vehicle 10 to autonomously follow trajectories defined by GPS waypoints. High-level sensors 250 may provide additional data to the high-level computing system 210, allowing potential obstacles to be avoided via the autonomous control system operating on the high-level computing system 210. Low-level control system 220 receives signals from low-level sensors 240, for example compass 230, and is used to control motor drivers 260 and thrusters 100.

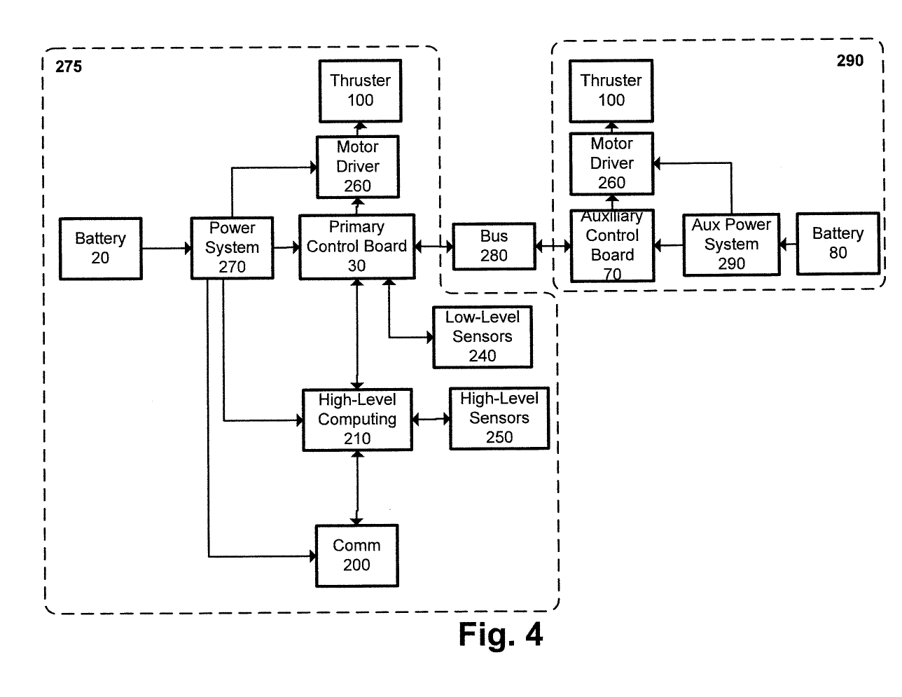

FIG. 4 shows an exemplary electrical architecture of an unmanned vehicle 10, wherein primary control module 275 and at least one auxiliary control module 290 are electrically connected via a suitable communication bus 280. In each module 275, 290 is a motor driver 260 and its associated thruster 100. The primary module 275 is powered by a battery 20 which has its power filtered, monitored, and distributed by a power system 270. Control of the system is done by the primary control board 30, which itself receives information from low-level sensors 240 and communicates with other control modules via the communication bus 280. FIG. 4 also details part of the architecture shown in FIG. 3, wherein high-level sensors 250 are connected to a high-level computing system 210, which communicates with a base station over a long-range communication system 200 and interfaces directly with the primary control board 30. Each auxiliary module 290 has a dedicated battery 80 and power system 290, and is controlled via an auxiliary control board 70, which itself responds to commands over the communication bus 280. Each power system 270, 290 is capable of self-monitoring and safety limiting, and can provide status updates as required to the relevant control board 30, 70.

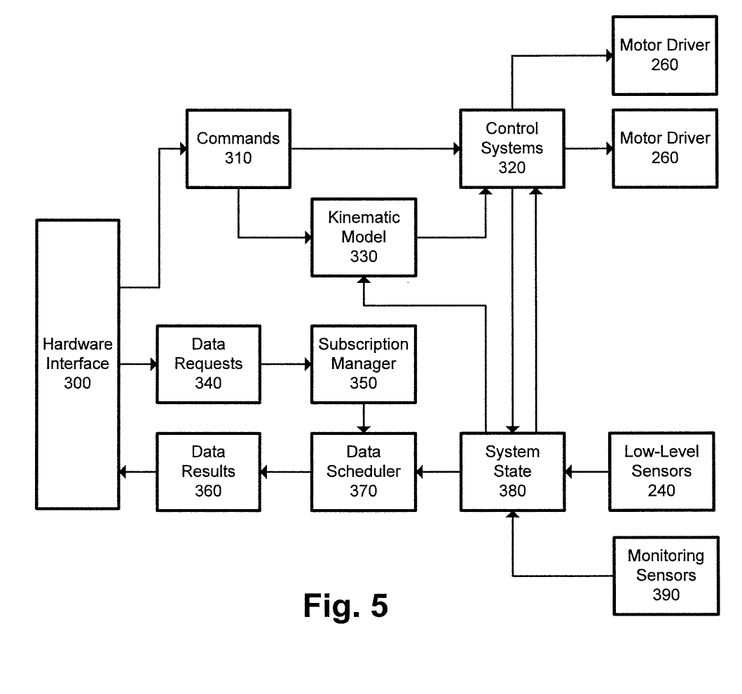

FIG. 5 shows an example of information flow within low-level control system of the exemplary unmanned vehicle 10. The hardware interface 300 provides full-duplex serial communication to the system, including error detection. The system can receive messages which make up commands 310 or data requests 340. Commands 310 can affect vehicle settings and setpoints directly or can be preprocessed by additional modules such as built-in vehicle kinematic models 330. Vehicle settings and setpoints are verified by a set of control systems 320 before being output to the motor drivers 260. The control systems 320 may also be capable of providing some degree of autonomy, if the low-level sensors 240 include localization hardware such as a GPS system 130. Settings and setpoints are stored in a central system state 380. System state 380 also contains data coming from the low-level MCU sensors 240 and onboard power monitoring sensors 390. Sensor data received from the MCU sensors 240 and monitoring sensors 390 may be raw data as received from the hardware, or filtered via analog and/or digital means. As well, the MCU sensors 240, monitoring sensors 390 and/or the motor drivers 360 may be physically located in different locations, in which case the electrical connectivity may be simplified by the use of well known communication buses such as SPI or CAN.

The system can be monitored remotely by issuing data requests 340. Data requests 340 can be structured to require immediate responses from the system, or can be subscriptions for periodic updates of specific data. The management of the varied requests and subscriptions is handled by a subscription manager 350. The subscription manager 350 is queried by a data scheduler 370 which uses this subscription information and the system state 380 to produce data 360 for the hardware interface 300. In this way, data 360 can thus be produced for the device on the other end of the hardware interface 300 without continual requests for such data, lowering the inbound bandwidth requirements.

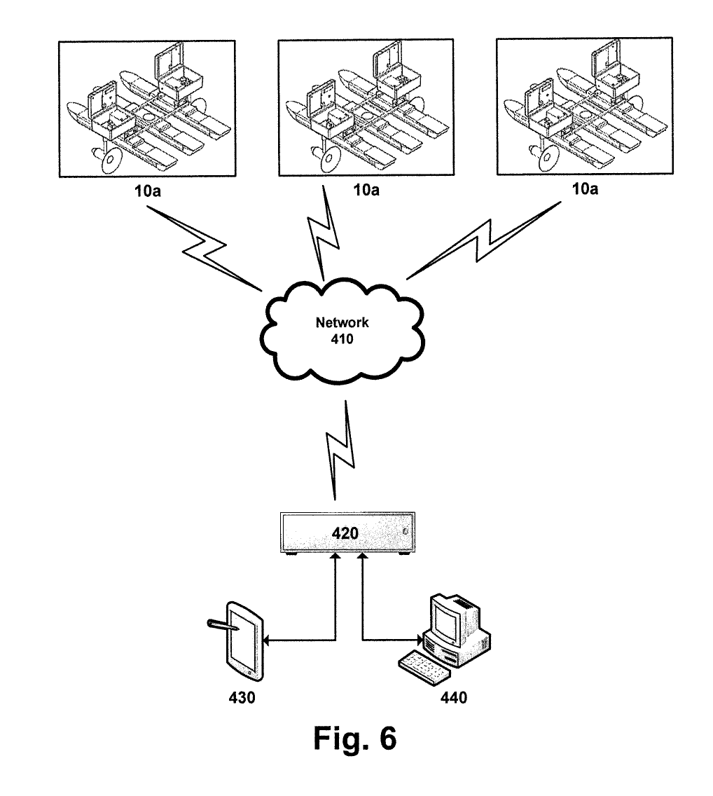

FIG. 6 shows a possible network topology of a control system for a plurality of unmanned vehicles 10a, each of which can be similar to vehicle 10. Vehicles 10a communicate over a shared network 410, which may be an 802.11a/b/g network or other networking system with the necessary range and bandwidth. A base station 420 connects to the shared network 410 and may itself be capable of controlling the vehicles 10a without user input. Other devices such as monitoring equipment 440 and control interfaces 430 can connect to the base station 420 for the purposes of monitoring and/or controlling individual vehicles 10a or the entire system as presented by the base station 420.

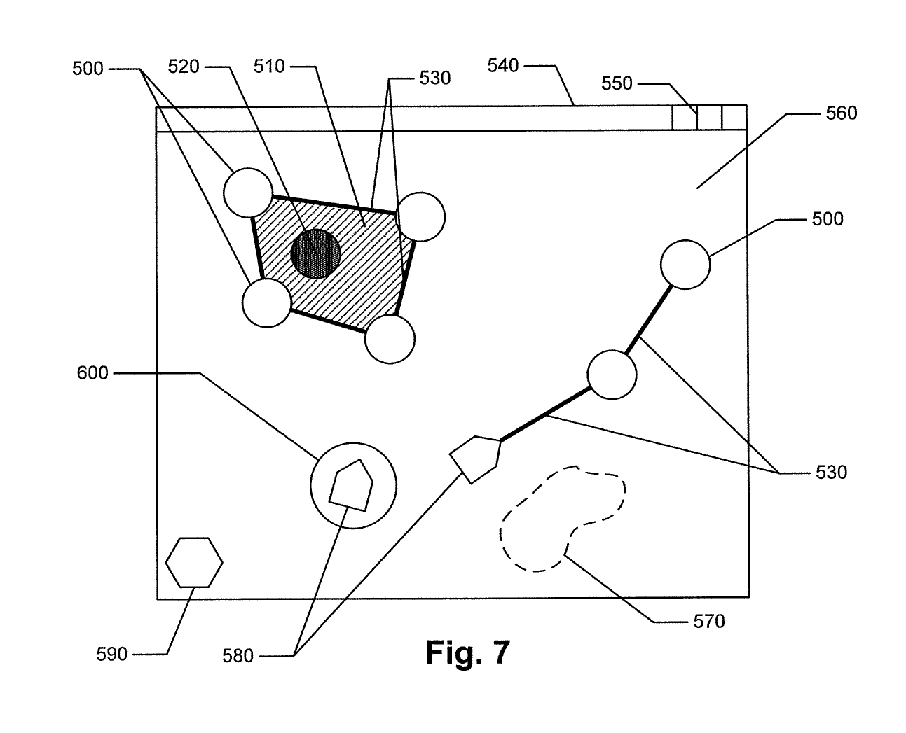

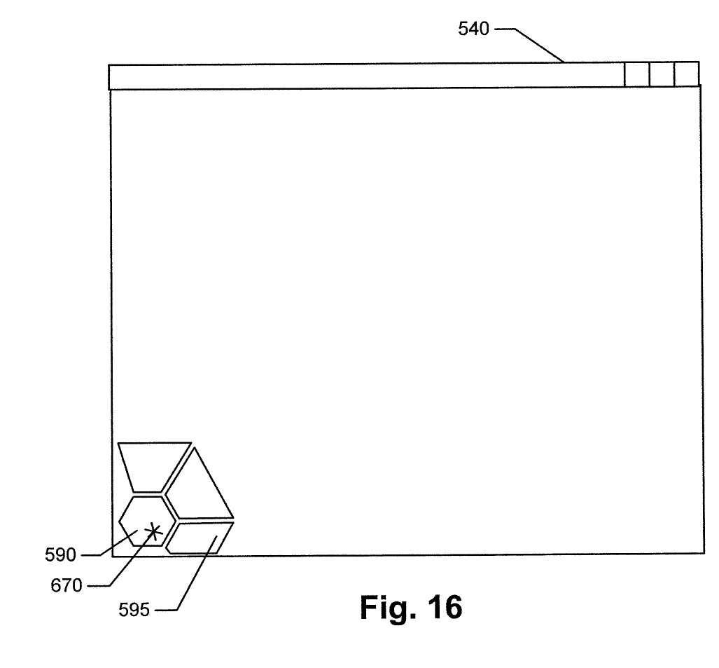

FIG. 7 depicts an exemplary control user interface for controlling an unmanned vehicle such as vehicles 10a which can be provided at control interface 430. However, it is appreciated that the control user interfaces described herein can be used with any suitable vehicle is within the scope of present implementations. For example, while the unmanned vehicle 10a is an aquatic unmanned platform, the user interfaces described herein can be included in unmanned vehicles, manned vehicles, aquatic vehicles, amphibious vehicles, aeronautic vehicles, any other suitable vehicle, and/or a combination, or the like. Monitoring equipment 440 and dedicated control interfaces 430 can each present an instance of a control application 540. The control application 540 may be run as an application on the relevant hardware 430, 440 or may run as a remote or local server where the control user interface is available via a web application. The control application 540 can be completely controlled via a resistive touchscreen or other similar combined display and input methods, as are known to those skilled in the art. For example, a traditional monitor and a one-button mouse are also capable of controlling the control application 540. The control application 540 presents an overhead map 560 to the user, which itself contains salient features 570. The control application 540 also possesses interface elements 550 which are dictated by the common look and feel of the operating system the control application 540 is operating within. Overlaid on the overhead map 560 are representations of vehicles 580 corresponding to the physical location of vehicle 10 and/or a plurality of vehicles 10a (e.g. as in FIGS. 1 and 6), though reference will be made to vehicles 10a in the following description. Key points 500 may also be visible on the overhead map 560. These key points 500 may be connected by line segments 530, either to form a linear path or to delineate an area 510. Areas 510 so delineated may also be marked at their centroids by area points 520. By use of the interface certain features on the map 560 may be selected and manipulated. Selected features are indicated by the appearance of a selection halo 600, surrounding the selected feature, for example a representation of a vehicle 580 as shown. Finally, the control application 540 allows the user to access secondary functions via the auxiliary menu 590, which is further detailed in FIG. 16. Preferably, control application 540 is generally free of menu bars, subwindows, dialog boxes, or other such features which would obstruct the users' view of the map 560. This lack of obstructions allows the screen space available to the control application 540 to be used to its fullest extent.

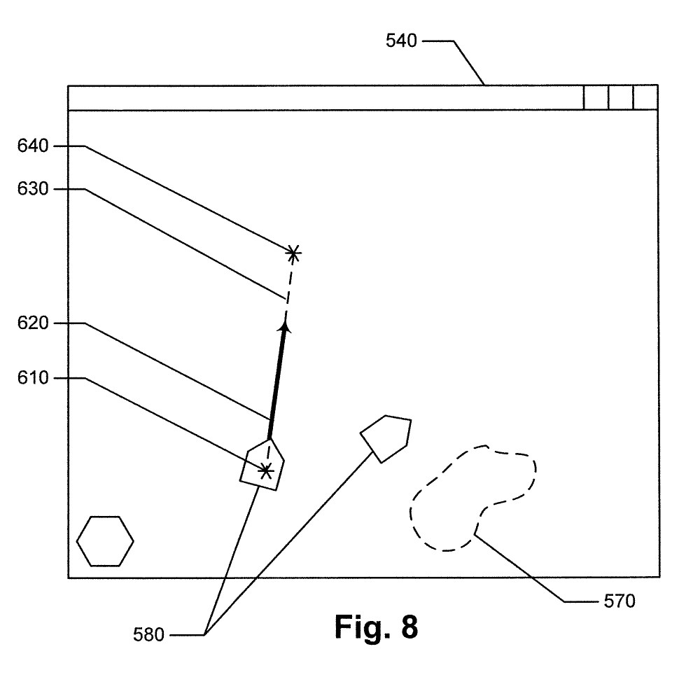

FIG. 8 depicts an exemplary control user interface for controlling an unmanned vehicle wherein the user takes manual control of an unmanned vehicle. The control application 540 can permit the immediate directional control of individual vehicles. In the embodiment shown, a user selects one of the set of vehicles represented 580 via an input event 610, which may include tapping a finger on a touch screen, a mouse click or other such suitable action, and indicates via a “click and drag” or similar operation a second point 640. The vector 630 created by the “click and drag” motion is transformed into a suitable translational 180 and rotational 170 velocity via the high-level computing system 210, and indicated as such by a graphical representation 620. In this way, the user can manually steer the representation of the vehicles 580 relative to each other and other map features 570 and the system will reposition the actual vehicles 10a accordingly.

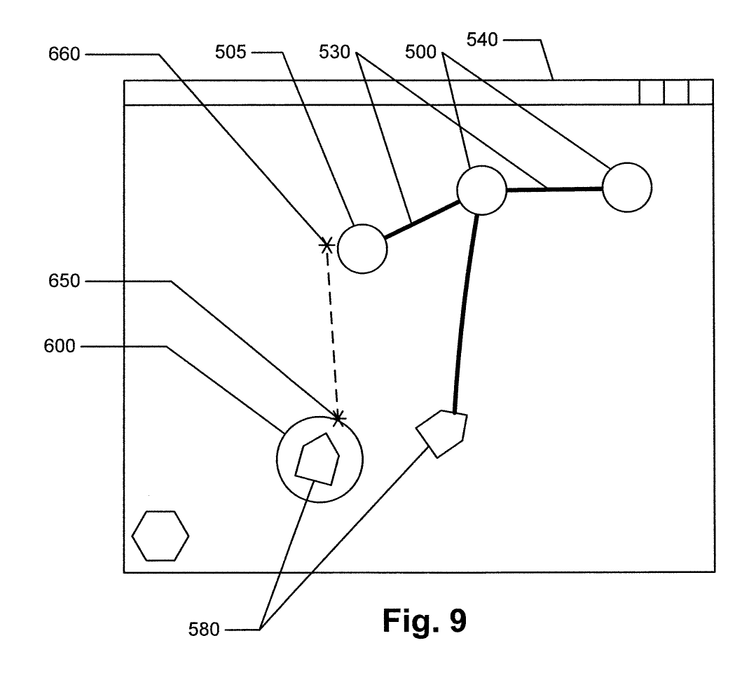

FIG. 9 depicts an exemplary control user interface for controlling an unmanned vehicle wherein the user directs an unmanned vehicle to proceed to a pre-existing key point or path. A path may be shown on the control application 540 as a combination of key points 500 and line segments 530. The control application 540 remains in the same mode as in the previous figures. Upon selection of a particular vehicle representation 580 a selection halo 600 appears. If the user indicates a point 650 on the selection halo 600 and drags to a new point 660 sufficiently near to an existing key point 505, the selected vehicle will be directed to move towards the physical location corresponding with existing key point 505. If the existing key point 505 is part of a path defined by key points 500 and line segments 530 then the selected vehicle may be directed to begin following the path upon arrival at the existing key point 505.

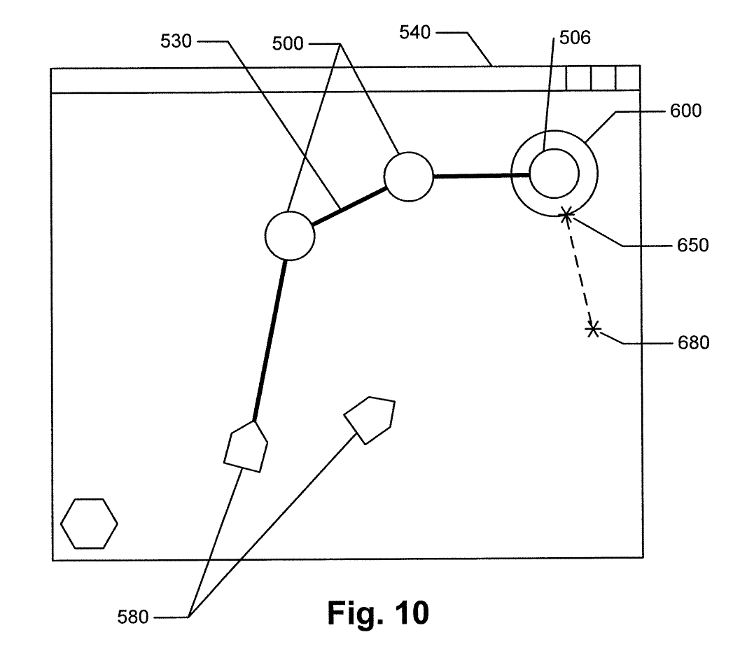

FIG. 10 depicts an exemplary control user interface for controlling an unmanned vehicle wherein the user extends a previously specified path for the unmanned vehicle to travel. The control application 540 can be used to extend a path during operation. Upon selection of a key point 506, at the end of a path, a selection halo 600 will appear. Indicating a point 650 on this halo and dragging to a new point 680 will create a new key point at the location 680, connected to the path by a new line segment. Vehicles 10a do not need to stop motion or re-plan as this is underway; they may continue to various key points 500, along path segments 530, or may maintain other operations.

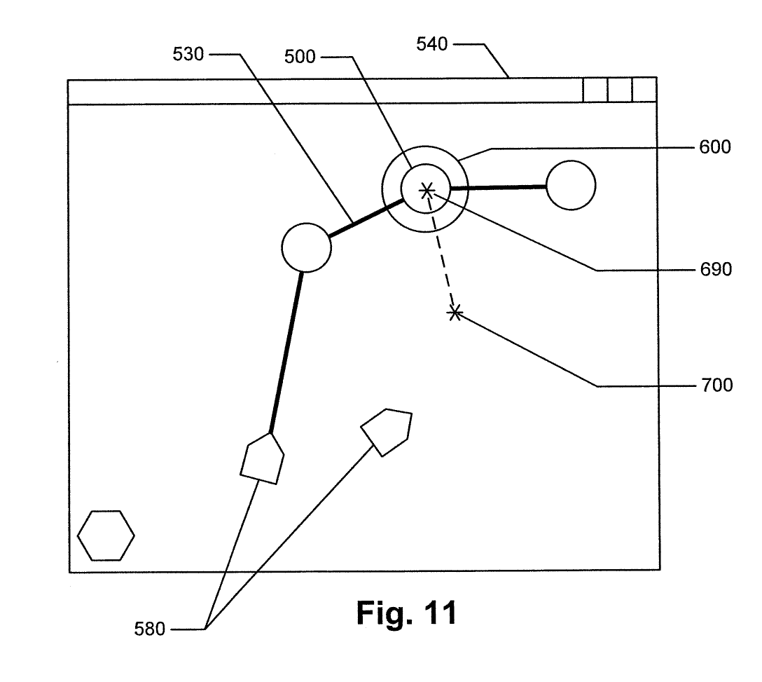

FIG. 11 depicts an exemplary control user interface for controlling an unmanned vehicle wherein the user moves a previously specified waypoint along a path. The operation may be done in a manner similar to FIG. 10. While the control application 540 is active, the user selects a key point 500 and allows the selection halo 600 to appear. When the next click 690 is well within the selection halo 600, a move has been indicated. Dragging the input interface to a new point 700 will move the selected key point 500 to the corresponding physical location.

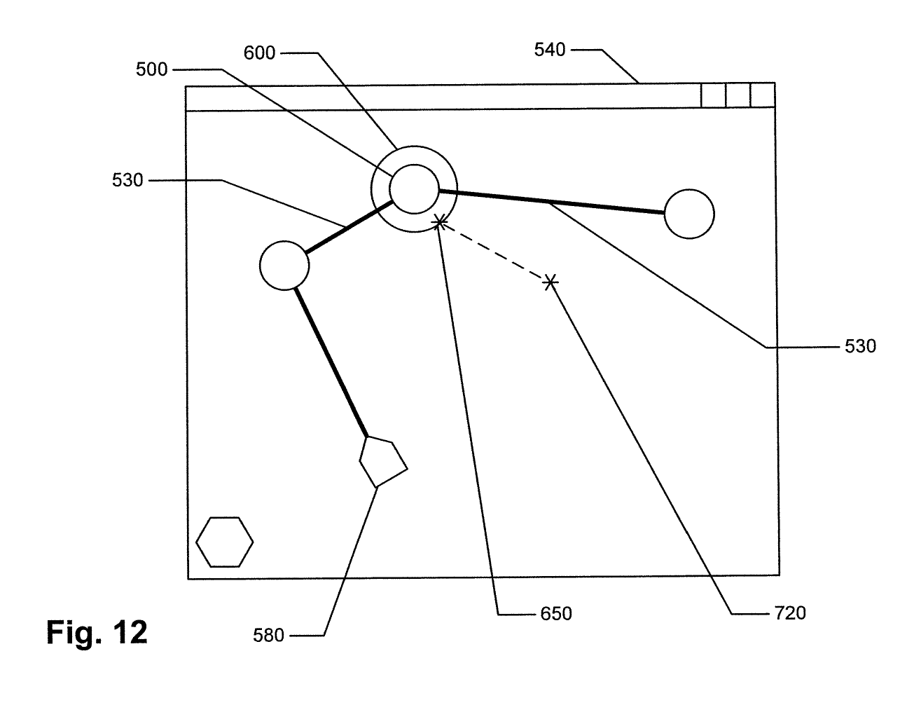

FIG. 12 depicts an exemplary control user interface for controlling an unmanned vehicle wherein the user inserts a waypoint into a previously specified path. A key point 500, which is not at the end of a path, is selected and a selection halo 600 appears. However, by clicking at a point 650 on the selection halo 600 instead of on the key point itself will initiate an “insert” mode, wherein a line segment 530 is segmented into two pieces separated by a new key point located at the point of selection release 720. The line segment which is selected for modification is one of the line segments 530 extending from the initially selected key point 500. The selection of the particular line segment 530 to be modified may be done by comparing the relative location of the point 650 on the selection halo 600 with the location of each line segment 530 and selecting the line segment 530 which the point 650 is closest to.

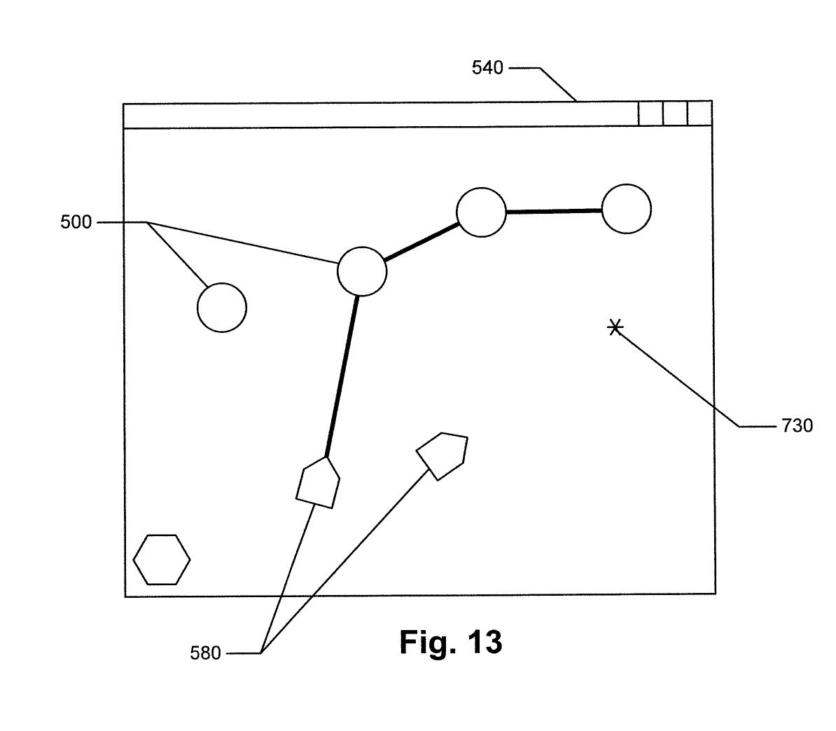

FIG. 13 depicts an exemplary control user interface for controlling an unmanned vehicle wherein the user adds a waypoint independent of a previously specified path. Upon the performance of a “double click” action at the desired location for a new key point 730, a new key point will be created. The vehicles 10a do not have to be interrupted in their missions for this to take place.

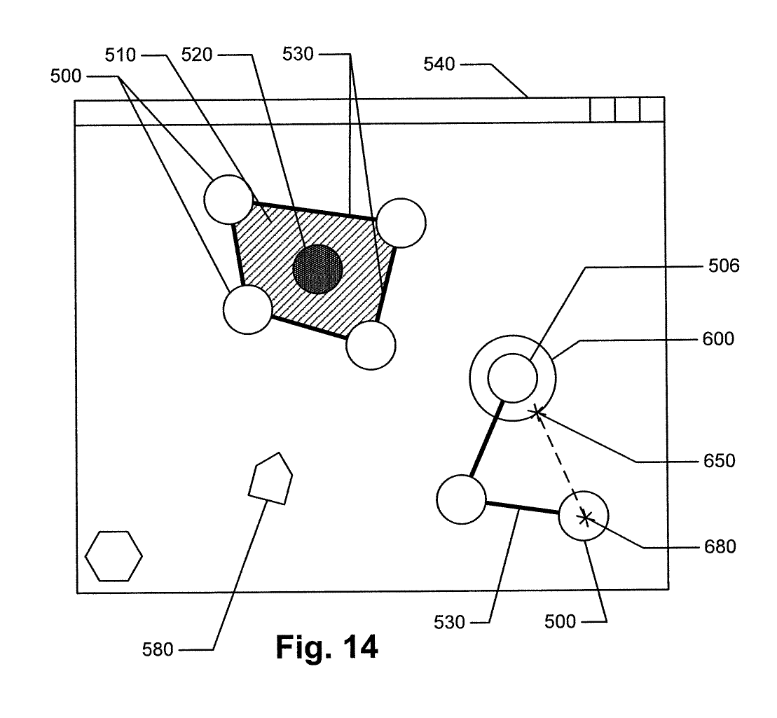

FIG. 14 depicts an exemplary control user interface for controlling an unmanned vehicle wherein the user delineates an area for use by the unmanned vehicle. The process of path creation and editing outlined by FIGS. 10-13 can be used to indicate closed areas 520 to the control application 540. As before, a key point at the end of a path 506 is selected and a selection halo 600 appears. Clicking on a point on the halo 650 and dragging to a new point 680 would typically extend a path as depicted in FIG. 9. However, if the new point 680 coincides with another key point 500, the path is considered closed and now delineates an area 510. Once this has occurred, an area point 520 appears which allows the corresponding area 510 to be moved or otherwise modified.

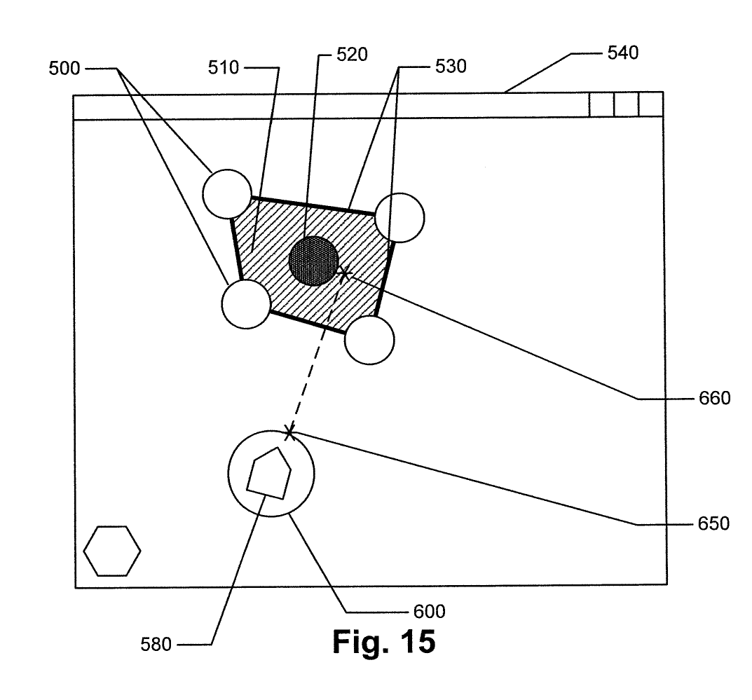

FIG. 15 depicts an exemplary control user interface for controlling an unmanned vehicle wherein the user assigns an unmanned vehicle to an area. The procedure may be analogous to the procedure for assigning a vehicle to a key point 500 or a path. As before, a point 650 on the selection halo 600 surrounding vehicle representation 580 is indicated and dragged to a point 660. If this point 660 is near an area point 520, the relevant vehicles 10a are assigned instead to perform area-specific tasks. Additionally, the key points 500 and connecting line segments 530 which delineate the area 510 remain usable as waypoints; if the user drags from the initial point 650 to a point 660 which is near a key point 500, the system will behave as depicted in FIG. 9 and will direct the vehicle 10a to a key point 500 or along the path defined by a set of key points 500. Since the key points 500 define a closed path in this instance, the vehicle 10a will indefinitely follow the path until directed otherwise.

It is appreciated that procedures described above provide for, among other things, generation and editing missions for an unmanned vehicle, designation of one or more paths and areas for an unmanned vehicle, assigning an unmanned vehicle to a given mission, providing a representation of an unmanned vehicle on the map based on the current position of the unmanned vehicle and receiving input data for controlling the unmanned vehicle.

FIG. 16 depicts an auxiliary function menu as part of an exemplary control user interface for controlling an unmanned vehicle. Upon clicking 670 on the auxiliary menu icon 590, a set of menus 595 appear. These menus may contain a variety of options, information, and configuration, as are commonly present in similar applications known to those skilled in the art, for example, “save,” “stop,” and the like.

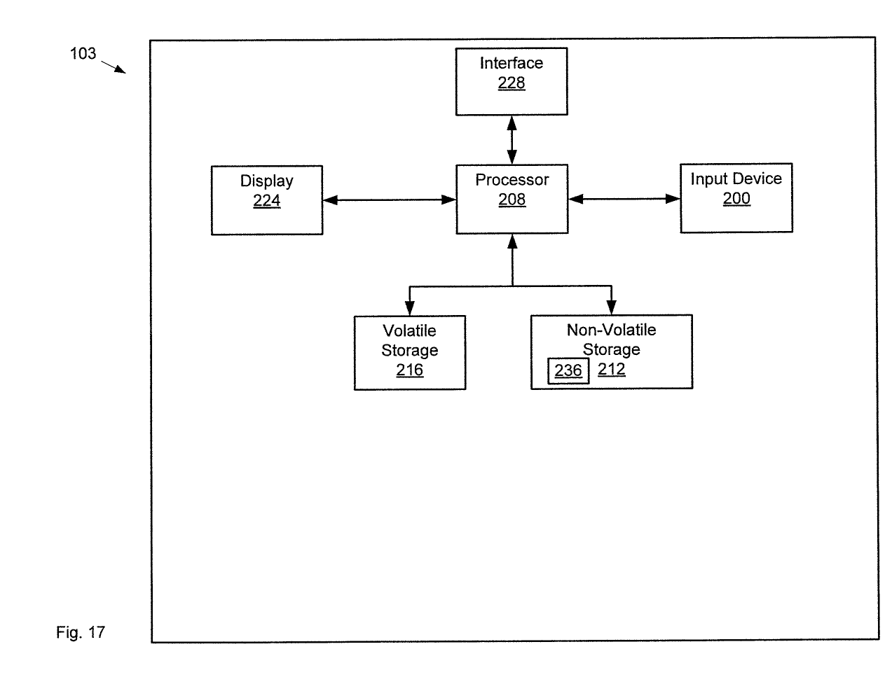

Attention is directed to FIG. 17 which depicts a schematic block diagram of control interface 430, according to non-limiting implementations. Control interface 430 comprises a can be any type of electronic device that can be used in a self-contained manner and to remotely interact with base station 420 and a plurality of vehicles 10a. It should be emphasized that the structure in FIG. 2 is purely exemplary.

Control interface 430 includes at least one input device 200. Input device 200 is generally enabled to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Input from input device 200 is received at processor 208 (which can be implemented as a plurality of processors). Processor 208 is configured to communicate with a non-volatile storage unit 212 (e.g. Erasable Electronic Programmable Read Only Memory (“EEPROM”), Flash Memory) and a volatile storage unit 216 (e.g. random access memory (“RAM”)). Programming instructions that implement the functional teachings of control interface 430 as described herein are typically maintained, persistently, in non-volatile storage unit 212 and used by processor 208 which makes appropriate utilization of volatile storage 216 during the execution of such programming instructions. Those skilled in the art will now recognize that non-volatile storage unit 212 and volatile storage 216 are examples of non-transitory computer readable media that can store programming instructions executable on processor 208. It is further appreciated that each of non-volatile storage unit 212 and volatile storage 216 are also examples of memory devices.

In particular, non-volatile storage 212 can store can store an application 236 for rendering control user interfaces of FIGS. 7 through 16 in a single window to remotely control a plurality of vehicles 10a, which can be processed by processor 208.

Processor 208 can also be configured to render data at display 224, for example upon processing application 236. Display 224 comprises any suitable one of or combination of CRT (cathode ray tube) and/or flat panel displays (e.g. LCD (liquid crystal display), plasma, OLED (organic light emitting diode), capacitive or resistive touchscreens, and the like).

In some implementations, input device 200 and display 224 are external to control interface 430, with processor 208 in communication with each of input device 200 and display 224 via a suitable connection and/or link.

Processor 208 also connects to a network interface 228, which can be implemented in some implementations as radios configured to communicate with base station 420 and/or a plurality of vehicles 10a over network 410. In general, it will be understood that interface 228 is configured to correspond with the network architecture that is used to implement network 410 and/or communicate with base station 420. It should be understood that in general a wide variety of configurations for control interface 430 are contemplated.

It is generally appreciated that control interface 430 comprises any suitable computing device enabled to process application 136 and communicate with base station 430 and/or a plurality of vehicles 10a, including but not limited to any suitable combination of personal computer, portable electronic devices, mobile computing device, portable computing devices, tablet computing devices, laptop computing devices, PDAs (personal digital assistants), cellphones, smartphones and the like. Other suitable computing devices are within the scope of present implementations.

Those skilled in the art will appreciate that in some implementations, the functionality of vehicles 10 10a, base station 420, control interface 430 and monitoring equipment 440 can be implemented using pre-programmed hardware or firmware elements (e.g., application specific integrated circuits (ASICs), electrically erasable programmable read-only memories (EEPROMs), etc.), or other related components. In other implementations, the functionality of vehicles 10, 10a, base station 420, control interface 430 and monitoring equipment 440 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

What is claimed is:

1. A system comprising,
a processor, a display, a communication interface and an input device, the processor enabled to:
communicate with an unmanned vehicle to receive current positional data from the unmanned vehicle and transmit commands to the unmanned vehicle, via the communication interface;
render a control user interface for the unmanned vehicle in a single window at the display, the control user interface comprising a map of a physical location of the unmanned vehicle; and
via the control user interface in the single window:
at least one of generate and edit a mission to designate one or more of paths and areas of movement for the unmanned vehicle via command input;
assign the unmanned vehicle to a given mission via further command input;
provide a representation of the unmanned vehicle on the map based on the current positional data; and
receive input data for controlling the unmanned vehicle,
such that the control user interface operates modelessly, and wherein the control user interface is independent of one or more of aspect ratio and resolution of the display.

2. The system of claim 1, wherein the processor is further enabled to, via the control user interface:
receive new key point data via the control user interface, the new key point data indicative of a position of a key point to be rendered on the map at the display device;
render a representation of the key point on the map;
receive a first indication via the control user interface that the unmanned vehicle be directed to move to the position corresponding to the key point; and,
render a path of the unmanned vehicle on the map from its current position to the position corresponding to the key point.

3. The system of claim 2 wherein the processor is further enabled to, via the control user interface:
receive a second indication via the control user interface that a given key point has been selected;
receive a third indication via the control user interface that the given key point is to be moved;
receive reassignment key point data via the control user interface, the reassignment key point data indicative of a given position to which the given key point is to be moved;
reassign the given key point to the location corresponding to the reassignment key point data; and
render a representation of the given key point on the map.

4. The system of claim 2 wherein the processor is further enabled to, via the control user interface:
receive additional new key point data via the control user interface, the additional new key point data indicative of a given position of an additional key point to be rendered on the map at the display device;
render a representation of the additional key point on the map at the display device;
receive a second indication via the control user interface that the key point and the additional key point be linked to change the path;
render changes to the path on the map; and
receive a third indication via the control user interface that the unmanned vehicle be directed to follow the changes to the path.

5. The system of claim 4 wherein the processor is further enabled to, via the control user interface:
receive further new key point data via the control user interface, the further new key point data indicative of a further given position of a further key point to be rendered on the map;
render a representation of the further key point on the map;
receive a fourth indication via the control user interface that the key point, the additional key point and the further key point are to be linked to enclose an area;
render a representation of the area on the map; and
receive a fifth indication via the control user interface that the unmanned vehicle be directed to the area thereby further changing the path.

6. The system of claim 1, wherein to provide the representation of the unmanned vehicle on the map based on the current positional data, the processor is further enabled to render a graphical representation of the unmanned vehicle on the map at a current location corresponding to the current location of the unmanned vehicle.

7. The system of claim 1, wherein the processor is further enable to transmit update commands to the unmanned vehicle in response to one or more of generating a mission, editing a mission, assigning the unmanned vehicle to the given mission, and receiving the input data for controlling the unmanned vehicle.

8. The system of claim 1, further comprising the unmanned vehicle.

9. The system of claim 8, wherein the unmanned vehicle comprises: a sensor enabled to sense at least one aspect of an environment of the unmanned vehicle; and a transmitter for transmitting sensor data to the processor, the processor further enabled to update the map to reflect the data regarding the at least one aspect of the environment.

10. The system of claim 9 wherein the sensor comprises a GPS sensor.

11. The system of claim 9 wherein the sensor comprises a camera.

12. The system of claim 1 wherein the processor, the display, the communications interface and the input device are incorporated into a handheld device.

13. The system of claim 1, further comprising a plurality of unmanned vehicles, the processor further enabled to
receive current positional data from each of the plurality of unmanned vehicles via the communication interface; and
render, on the map, a representation of each of the plurality of unmanned vehicles.

14. The system of claim 1 further comprising a controller, wherein communications between the unmanned vehicle and with the processor occurs via the controller.

15. The system of claim 14 wherein the controller comprises wireless communications hardware.

16. The system of claim 14 wherein the controller is located on the unmanned vehicle.

17. The system of claim 14 wherein the controller comprises a software module and the processor is further enabled to execute the software module.

18. The system of claim 1, wherein the control user interface further comprises an auxiliary menu icon which, when actuated, causes the processor to render at least one command interface on the map and wherein the map is otherwise rendered without the at least one command interface.

19. The system of claim 1 wherein the input device comprises at least one of a touch screen, a tablet computer, a mouse and a mobile phone.
